(19) United States
(12) Patent Application Publication
(10) Pub. No.: US 2021/0187680 A1
(43) Pub. Date: Jun. 24, 2021

(54) COMPLIANT TOOL CARRIER

(71) Applicant: Scott Technology Limited, Dunedin (NZ)

(72) Inventor: Andrew James THOMSON, Kaiapoi (NZ)

(73) Assignee: Scott Technology Limited, a New Zealand company of 630 Kaikorai Valley Road, Dunedin, Dunedin (NZ)

(21) Appl. No.: 17/119,338

(22) Filed: Dec. 11, 2020

(30) Foreign Application Priority Data
Dec. 20, 2019 (AU) 2019904851
Dec. 2, 2020 (AU) 2020900390

(51) Int. Cl. B23Q 3/155; B25J 15/00

(52) U.S. Cl. CPC B23Q 3/15526; B25J 15/0052; B25J 15/0019

(57) ABSTRACT

A tool carrier including a base and a tool mount. The tool mount is separated from the base in a first direction and has a first orientation with respect to the base. The tool mount is arranged to be compliant in second and third directions that are transverse to the first direction while remaining substantially in the first orientation.

### CROSS REFERENCE TO RELATED APPLICATIONS

This application which claims benefit of Serial No. 2019904851, filed 20 Dec. 2019 in Australia and Serial No. 2020900390, filed 12 Feb. 2020 in Australia and which applications are incorporated herein by reference. To the extent appropriate, a claim of priority is made to each of the above disclosed applications.

### FIELD

This invention relates to a compliant tool carrier.

### BACKGROUND

Tools are used for performing various operations. Tools may be carried on tool carriers. Tool carriers may be mounted to robot arms. It may be useful for tool carriers to be compliant to external forces to prevent tools from damaging workpieces, prevent damage to tools, and to allow tools to passively follow the profile of part of a workpiece.

Some tool carriers may be complex and have many degrees of freedom. Some tool carriers may use active feedback control systems and powered actuators to control their movement in response to external forces. Such tool carriers can be expensive and require complex control systems.

### SUMMARY

According to one example embodiment there is provided a tool carrier comprising:
a base; and
a tool mount separated from the base in a first direction and having a first orientation with respect to the base;
wherein the tool mount is arranged to be compliant in second and third directions transverse to the first direction while remaining substantially in the first orientation.

Embodiments may be implemented according to any one of the dependent claims 2 to 14.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is an isometric view of a tool carrier according to one embodiment with a tool mount in a first position;

FIG. 2 is an isometric view of the tool carrier of FIG. 1 with the tool mount in a second position;

FIG. 3 is an isometric view of the tool carrier of FIG. 1 with the tool carrier in a third position;

FIG. 4 is an isometric view of the tool carrier of FIG. 1 in a fourth position;

FIG. 5 is a front view of the tool carrier of FIGS. 1 to 4 with a tool mount in four different positions;

FIG. 6 is an isometric view of an alternative tool carrier; and

FIG. 7 is an isometric view of the tool carrier of FIG. 6 from a different perspective.

### DETAILED DESCRIPTION

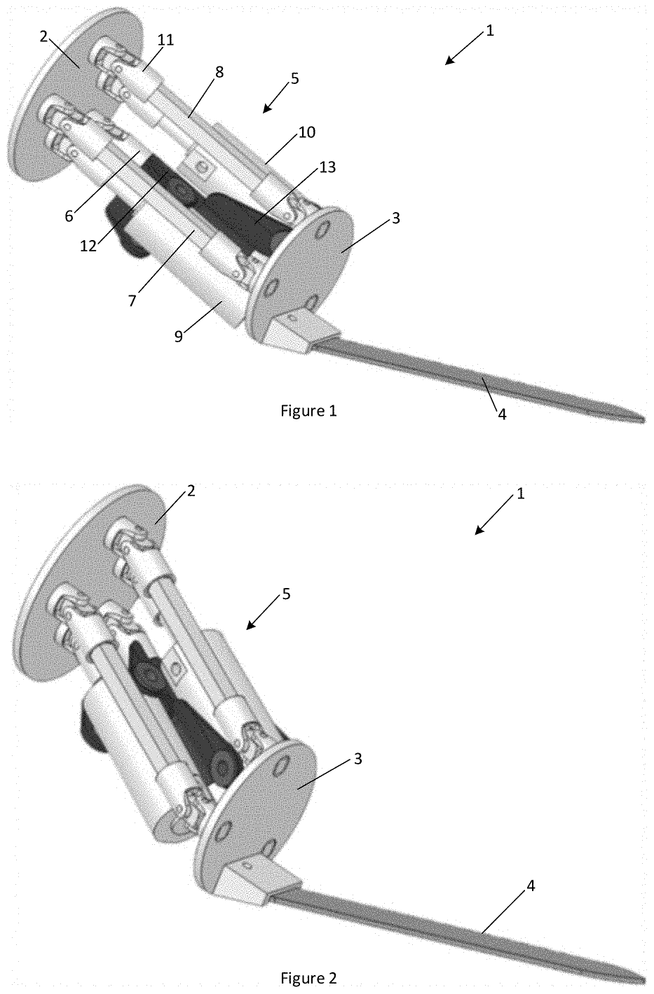

FIG. 1 illustrates a tool carrier according to an example embodiment. In this example, the tool carrier is a blade carrier and the tool mount is a blade mount. This is only one exemplary use and the tool carrier may be used with various tools mounted to the tool mount.

The blade carrier 1 includes a base 2, a blade mount 3 and a linkage 5. The blade mount 3 holds a blade 4. The linkage 5 is one example of a mechanical assembly providing a mechanical constraint on the blade mount 3 to constrain it to be in a substantially constant orientation.

The linkage 5 is arranged to allow the blade 4 to translate in two directions while staying at a fixed angle to the base 2. The blade mount 3 is separated from the base 2 in one direction. The blade mount 3 can translate in directions transverse to this direction of separation. Keeping the blade 4 at a fixed angle may be useful when cutting or scraping meat from bones. The translation of the blade mount 3 allows it to be compliant in these two directions. In particular, when a force is applied to the blade mount from an external object, the blade mount can comply to some degree to this force by moving in the direction of the applied force. This compliance may be useful when cutting or scraping meat from bones by allowing a blade to “ride” along the bone and follow its profile without the need for active control of the blade's position based on feedback or position measurements.

The linkage 5 is a parallel motion linkage. The linkage includes parallel rods 6, 7 and 8 arranged in a prism. In particular, the ends of the rods 6, 7 and 8 define the vertices of the prism. The rods extend along edges of the prism between the two parallel polygonal ends of the prism to form parallelograms between each pair of rods. In particular, the ends of the pairs of rods define the vertices of the parallelograms. The ends of the rods 6, 7 and 8 are pivotally coupled to the base 2 and the blade mount 3 by universal joints 11 (only one of which is indicated). The universal joints 11 provide the rods 6, 7 and 8 with two rotational degrees of freedom.

Because the rods 6, 7 and 8 are pivotally coupled with two degrees of rotational freedom, the blade mount 3 can move in two different directions with respect to base 2. The parallel linkage formed by the rods 6, 7 and 8 ensures that the polygonal ends of the prism remain parallel with each other during this movement and the blade mount 3 stays in a substantially fixed orientation with respect to the base 2. Because the blade 4 is held by the blade mount 3, the blade 4 stays at the same angle to the base 2 during this movement. In this example, there are three rods 6, 7 and 8 and the prism is a triangular prism, although more rods could be used to form prisms with more sides.

Alternative connections between the base and the tool mount could be used to allow compliance in two directions while remaining at a fixed angle. For example, an X-Y guide having two transverse rails could be provided between the base and the tool mount. In the X-Y guide, one of the rails would be able to slide on the other and one or both of the base and the tool mount would be able to slide along a respective rail. The combination of sliding movements in the two directions would allow the tool mount to comply in the plane of the rails while remaining in a fixed orientation. In another example, roller bearings movable on a planar bearing surface could be provided between the base and the tool mount to allow compliance in two directions.

As shown in FIGS. 1 and 2, the blade mount 3 and blade 4 can move in one direction while retaining the blade 4 at a fixed angle to the base 2. In FIG. 2, the blade 4 has moved from the position shown in FIG. 1 approximately in the plane of the blade 4.

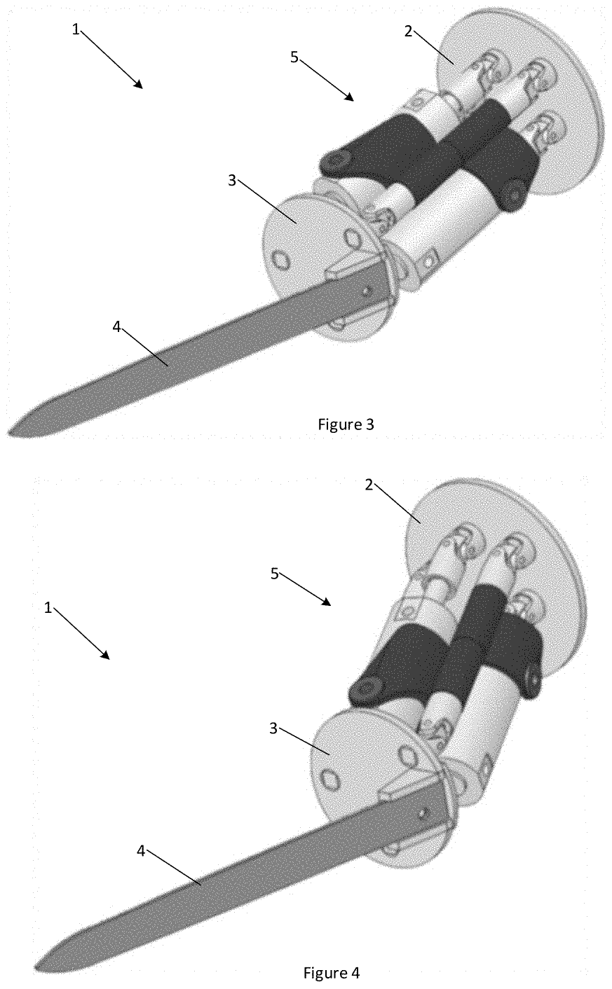

As shown in FIGS. 3 and 4, the blade mount 3 and blade 4 can move in a second direction while remaining in a fixed orientation with respect to the base 2. In FIG. 4, the blade 4 has moved from the position shown in FIG. 3 in a direction transverse to the plane of the blade 4.

The movement of the blade mount 3 may be controlled by pneumatic cylinders 9 and 10. The cylinders 9, 10 are connected to the rod 6 by sleeves 12 and 13, respectively. The cylinders 9, 10 are connected to the base 2 by universal joints 11 to provide them with two rotational degrees of freedom. The cylinders 9 and 10 each lie at a non-zero angle to the rods 6, 7 and 8. The cylinders 9 and 10 are also of variable extension. To allow the blade mount 3 to translate with respect to the base 2, the extension of at least one of the cylinders 9 and 10 can change.

The cylinders 9, 10 are arranged at a non-zero angle to each other. This allows them to control movement of the blade mount 3 in different directions. In one example, the attachment points of the cylinders 9 and 10 and the rod 6 to the base 2 form a right-angled triangle with the attachment point of the rod 6 being opposite the hypotenuse and the attachment points of the cylinders 9 and 10 being at 90° to each other about the attachment point of the rod 6. This may ensure that the cylinders 9, 10 control the movement of the blade mount 3 largely in different directions for optimal control.

By adjusting the resistance of the cylinders 9 and 10 to changes in extension, the compliance of the blade mount 3 (and therefore the blade 4) to external forces can be adjusted. The resistance to changes in extension may be adjusted by changing the pressure in one or both of the pneumatic cylinders 9, 10. The pressure in each cylinder can be controlled independently of the pressure in the other cylinder to control the compliance in different directions separately. The cylinders 9, 10 can be connected to an external source of pressurised gas and to a pressure release vent to allow the pressure in the cylinders 9, 10 to be increased or decreased as needed.

Using cylinders allows the blade mount 3 to passively comply to forces. Because the cylinders have a relatively low resistance to movement of the blade mount at or near its rest position, they will be naturally quite compliant to movement from this position. This obviates the need for a control system that actively drives or allows movement of the blade mount in the same direction as an applied force.

Alternatively, springs or other compliant elements could be used to provide the blade mount with compliance.

The movement of the blade mount 3 (and therefore a mounted blade) can also be driven by controlling the extension of the cylinders. By controlling the pressure in one or both cylinders, the extension of that/those cylinder(s) can be controlled between extended and retracted positions. The cylinders 9, 10 may be able to be controlled to partly extended positions.

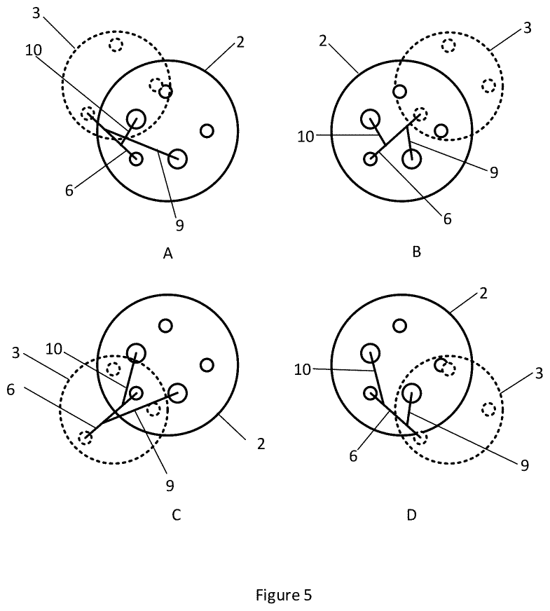

FIG. 5 shows the blade mount 3 (shown in dotted lines for clarity) in four different positions. These positions correspond to four different combinations of cylinder extension/retraction as shown in the table below:

| Position | Cylinder 9 | Cylinder 10 |
|---|---|---|
| A | Extended | Retracted |
| B | Retracted | Retracted |
| C | Extended | Extended |
| D | Retracted | Extended |

As shown in FIG. 5, the cylinders 9, 10 act on the rod 6 to move the blade mount 3 between positions A, B, C and D as dictated by the combinations of states (extended or retracted) of the cylinders 9, 10.

Alternatively, linear actuators or other actuable elements could be used to move the blade mount between different positions.

The blade carrier 1 can be used with a robotic system such as a meat processing system. In particular, it can be mounted to a robot arm at the base 2. The robot arm can move the blade carrier 1 into a desired position and orientation for cutting or scraping meat from a bone. The position of the blade mount 3 relative to the base 2 can also be controlled based on the operation to be performed (cutting or scraping). The blade can then be used to cut the meat or scrape it from the bone, while being compliant to forces acting on the blade. This means that the blade will be deflected (along with the blade mount) substantially in the direction of a force applied to it. This force may be due to the blade encountering bone in a meat processing example. The blade may then follow or “ride on” the bone while remaining at a substantially constant angle.

Robotic systems are typically automated to perform operations based on known geometry of workpieces. In some applications, workpieces can have a range of sizes, shapes and structures that need to be taken into account by the system. For example, in a meat processing context sections of carcass of different animals can have different sizes, shapes and bone structure. The tool carrier can allow a robotic system to be programmed with a standard set of instructions based on a theoretical average or otherwise representative section of carcass. This could define a standard path or set of movements of a blade mounted to the tool carrier. The compliance of the blade carrier would allow the blade to deviate from a standard path or movement to account for the specific geometry of the section of carcass being processed. This may allow an automated system to be programmed according to a simple set of standard instructions while the blade carrier passively complies to the size, shape and structure of the section of carcass being processed to tailor the processing to each section of carcass.

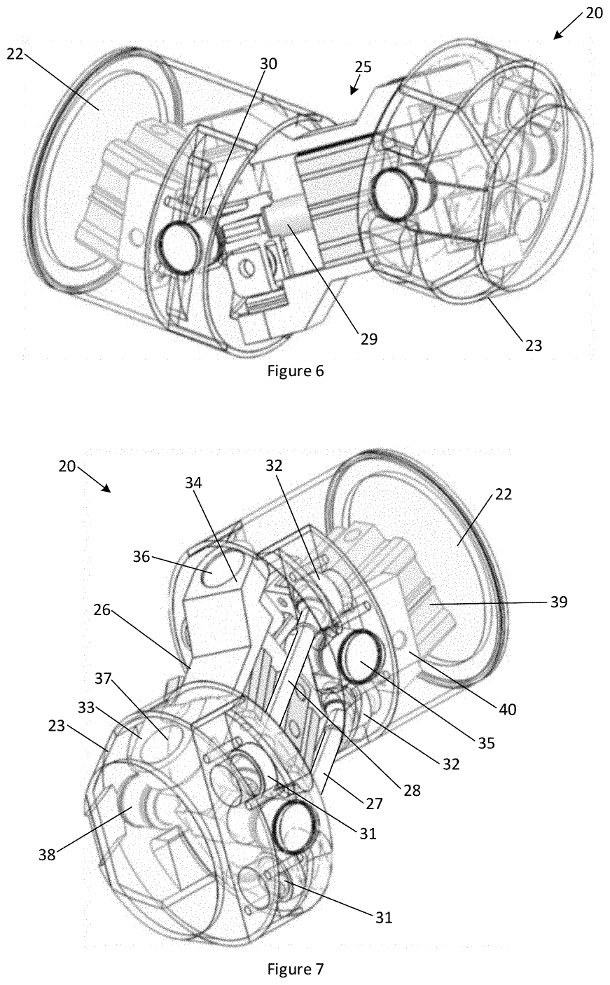

FIGS. 6 and 7 show an alternative embodiment of the tool carrier with a different linkage.

In this example, the tool carrier 20 includes a base 22, a tool mount 23 and a linkage 25 that couples the base 22 to the tool mount 23. The linkage 25 includes a parallel motion linkage made up of rod—in the form of an arm 26—and rods 27 and 28. The rods 27 and 28 are coupled to the base 22 by ball and socket joints 32 and to the tool mount 23 by ball and socket joints 31. The arm 26 is coupled to the base 22 by universal joint 34 and to the tool mount 23 by universal joint 33. Universal joint 34 is made up of a pair of swivels 35 and 36 and universal joint 33 is made up of a pair of swivels 37 and 38.

The movement of the tool mount 23 is controlled by cylinders 29 and 30 (partly obscured). In this example, cylinder 29 acts on arm 26 part way along its length to control the movement of the tool mount 23 in one direction—approximately left-right in FIGS. 6 and 7. Specifically, the cylinder 29 is coupled between the arm 26 and swivel 35 that is fixed with respect to the base 22. Pivoting of the arm 26 about the swivel 36 causes extension or retraction of the cylinder 29. Compliance of the cylinder 29 to such extension or retraction determines the compliance of the arm 26 about the swivel (in the approximately “left-right” direction). Also, the cylinder 29 can be controlled to extend or retract to pivot the arm 26 about the swivel 36. The couplings between the cylinder 29 and the arm 26 and between the cylinder 29 and the swivel 35 are pivotal couplings to allow pivoting of the cylinder 29 as the arm 26 pivots about swivel 36.

The cylinder 30 acts on arm 26 near its connection to the base (via swivel 35) offset from the midline of the arm 26 to control movement in another direction—approximately up-down in FIGS. 6 and 7. Specifically, the cylinder 30 is coupled between cylinder housing 39 and swivel 36 that is fixed with respect to the arm 26. Cylinder housing is attached to the base 22 via clevis 40. Pivoting of the arm 26 about the swivel 35 causes extension or retraction of the cylinder 30. Also, the cylinder 30 can be controlled to extend or retract to pivot the arm 26 about the swivel 35. The couplings between the cylinder 30 and the swivel 36 and between the cylinder housing 39 and the clevis 40 are pivotal couplings to allow pivoting of the cylinder 30 as the arm 26 pivots about swivel 35.

Because the arm 26 and rods 27 and 28 form a parallel linkage, the rods 27 and 28 also pivot when the arm 26 pivots while remaining parallel to each other. This means that the tool mount 23 translates while remaining in a substantially fixed orientation with respect to the base.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A tool carrier comprising:
a base; and
a tool mount separated from the base in a first direction and having a first orientation with respect to the base;
wherein the tool mount is arranged to be compliant in second and third directions transverse to the first direction while remaining substantially in the first orientation.

2. The tool carrier of claim 1, wherein the tool mount is mechanically constrained to remain substantially in the first orientation.

3. The tool carrier of claim 1, wherein tool mount is compliant to externally applied forces in the second and third directions.

4. The tool carrier of claim 1, wherein the tool carrier is passively compliant in the second and third directions.

5. The tool carrier of claim 1, wherein the compliance of the tool mount in the second direction is different from the compliance of the tool mount in the third direction.

6. The tool carrier of claim 1, configured to allow adjustment of the compliance of the tool mount in the second direction and/or in the third direction.

7. The tool carrier of claim 1, further comprising cylinders to control the compliance in the second and third directions.

8. The tool carrier of claim 7, when dependent on claim 6, wherein the compliance of the tool mount is adjustable by adjusting the pressure in one or more of the cylinders.

9. The tool carrier of claim 8, wherein the cylinders are further configured to drive the tool mount to translate in the second and third directions.

10. The tool carrier of claim 1, wherein the tool mount and the base are coupled by a linkage comprising three or more parallel rods arranged in a prism, each rod being pivotally coupled between the base and the tool mount.

11. The tool carrier of claim 10, when dependent on any one of claims 7 to 9, wherein a first one of the cylinders is coupled between the base and one of the rods and a second cylinder is coupled between the base and the one of the rods, and wherein the first one of the cylinders and the second one of the cylinders are inclined with respect to each other and with respect to the rods.

12. The tool carrier of claim 10, when dependent on any one of claims 7 to 9, wherein one of the rods is coupled to the base by a universal joint having a first swivel fixed with respect to the base and a second swivel fixed with respect to the one of the rods, and wherein a first one of the cylinders is coupled between the base and the second swivel at a point offset from the middle of the second swivel and wherein a second one of the cylinders is coupled between the one of the rods and the first swivel at a point offset from the middle of the first swivel.

13. The tool carrier of claim 1, wherein the base is configured to be mounted to a robotic arm.

14. The tool carrier of claim 1, further comprising a blade mounted to the tool mount.
